(19) United States
(12) Patent Application Publication
(10) Pub. No.: US 2025/0335855 A1
(43) Pub. Date: Oct. 30, 2025

(54) SUPPLY CHAIN MANAGING DEVICE, SUPPLY CHAIN MANAGING METHOD, AND SUPPLY CHAIN MANAGEMENT SYSTEM

(71) Applicant: HITACHI, LTD., Tokyo (JP)

(72) Inventors: Mika Takata, Tokyo (JP); Tsunehiko Baba, Tokyo (JP)

(73) Assignee: HITACHI, LTD., Tokyo (JP)

(21) Appl. No.: 19/078,519

(22) Filed: Mar. 13, 2025

(30) Foreign Application Priority Data
Apr. 25, 2024 (JP) 2024-071478

(51) Int. Cl. G06Q 10/0635

(52) U.S. Cl. CPC G06Q 10/0635

(57) ABSTRACT

Provided are a supply chain managing device, a supply chain managing method, and a supply chain management system that can evaluate a risk to a supply chain with higher accuracy by indicating the risk to the supply chain on the basis of a more appropriate scale.

The supply chain managing device includes a risk data obtaining section configured to obtain risk data, a risk degree calculating section configured to obtain a risk degree corresponding to a type of the risk on the basis of the risk data, a scale calculating section configured to obtain a scale as a spatial position suitable for representing the risk, on the basis of the risk degree, and a risk estimating section configured to obtain the risk value at a specified spatial position, the risk value corresponding to the scale.

### BACKGROUND OF THE INVENTION

### 1. Field of the Invention

The present invention relates to a supply chain managing device, a supply chain managing method, and a supply chain management system. The present invention particularly relates to a supply chain managing device and the like that can evaluate a risk to a supply chain.

### 2. Description of the Related Art

In recent years, the globalization of corporate activities has created a desire for robustness in dealing with a wide range of various risks. For the robustness of a supply chain, there is a desire to visualize the whole of the supply chain and recognize risks.

JP-2020-38361-A discloses that, in a map generation system, a processor performs obtaining at least one image representing the environment of a vehicle from an imaging device, analyzing the image and calculating the position of a land mark with respect to a road on which the vehicle has traveled, uploading map information including information regarding the position of the land mark to a server, and statistically determining the coordinates of each individual land mark in the uploaded map information. At least one of the land marks is defined as a reference mark whose absolute coordinates are determined in advance by a survey, and the coordinates of other land marks except the reference mark in the uploaded map information are corrected such that the coordinates of the land mark corresponding to the reference mark among the included land marks are adjusted to the absolute coordinates.

PCT Patent Publication No. WO2016/094958 discloses a method and a device for geopositioning geographical data for visualizing a geographical region, particularly a mine site. Here, two or more data sources including geographical information are handled, and the geographical data is visualized with use of information in a first data source and information in a second data source.

### PTL1: JP-2020-38361-A

### PTL2: WO2016/094958

### SUMMARY OF THE INVENTION

In a conventional technology, when a plurality of risk data sources are collected, the positional information of respective risks may be recorded on respective different scales (for example, a country, a municipality, and a latitude and a longitude). Hence, as risks to the supply chain, the weights of the respective risks have to be observed on varying scales. Alternatively, the risks to the supply chain have to be observed according to the largest scale. As a result, a threat to the supply chain may not be able to be observed correctly. In addition, even in a case where it suffices to be able to observe only the outline, risks may be observed on an unnecessarily fine scale (for example, a latitude and a longitude).

It is an object of the present invention to provide a supply chain managing device, a supply chain managing method, and a supply chain management system that can evaluate a risk to a supply chain with higher accuracy by indicating the risk to the supply chain on the basis of a more appropriate scale.

In order to solve the above problems, according to the present invention, there is provided a supply chain managing device including a risk data obtaining section configured to obtain risk data including a relation between a spatial position and a risk value, as data related to a risk affecting a supply chain, a risk degree calculating section configured to obtain a risk degree corresponding to a type of the risk on the basis of the risk data, a scale calculating section configured to obtain a scale as a spatial position suitable for representing the risk, on the basis of the risk degree, and a risk estimating section configured to obtain the risk value at a specified spatial position, the risk value corresponding to the scale. In this case, it is possible to provide a supply chain managing device that can evaluate a risk to a supply chain with higher accuracy by indicating the risk to the supply chain on the basis of a more appropriate scale.

Here, for example, the risk degree calculating section obtains the risk degree on the basis of a human risk degree as a risk degree with regard to a human and a supply chain risk degree as a risk degree with regard to the supply chain. In this case, the risk degree corresponding to the supply chain can be obtained comprehensively including the human risk degree.

In addition, for example, the risk degree calculating section obtains the risk degree by representing the human risk degree and the supply chain risk degree by numerical values and calculating a weighted average of the respective numerical values of the human risk degree and the supply chain risk degree. In this case, the calculation of the risk degree is facilitated.

Further, for example, the scale calculating section obtains the scale according to magnitude of the risk degree. In this case, an appropriate scale can be set for the magnitude of the risk degree.

Further, for example, the scale calculating section obtains the scale on the basis of information concerning a scale input from a user, in addition to the magnitude of the risk degree. In this case, it is possible to determine the scale while incorporating a request from the user.

Further, for example, the risk estimating section calculates the risk value corresponding to the scale on the basis of a magnitude relation between the spatial position included in the risk data and the scale calculated by the scale calculating section. In this case, the risk value included in the risk data can be corrected to be a more appropriate risk value.

In addition, for example, the risk estimating section calculates the risk value corresponding to the scale by decreasing, according to the scale, the risk value included in the risk data, when the scale represents a smaller area than the spatial position included in the risk data, and calculates the risk value corresponding to the scale by increasing, according to the scale, the risk value included in the risk data, when the scale represents a larger area than the spatial position included in the risk data. In this case, increasing or decreasing the risk value according to the size of the spatial position makes it possible to calculate a more appropriate risk value.

Further, for example, the risk estimating section calculates the risk value corresponding to the scale on the basis of a rank set for a user. In this case, the risk value included in the risk data can be corrected to be a more appropriate risk value according to the rank set for the user.

Furthermore, for example, according to a magnitude relation between a numerical value indicating the rank and a predetermined threshold value, the risk estimating section determines whether to calculate the risk value corresponding to the scale by decreasing, according to the scale, the risk value included in the risk data, or calculate the risk value corresponding to the scale by increasing, according to the scale, the risk value included in the risk data. In this case, increasing or decreasing the risk value according to the rank set for the user makes it possible to calculate a more appropriate risk value.

In addition, the present invention can provide a supply chain managing method performed by a processor executing a program recorded in a memory, the supply chain managing method including obtaining risk data including a relation between a spatial position and a risk value, as data related to a risk affecting a supply chain, obtaining a risk degree corresponding to a type of the risk on the basis of the risk data, obtaining a scale as a spatial position suitable for representing the risk, on the basis of the risk degree, and obtaining the risk value at a specified spatial position, the risk value corresponding to the scale. In this case, it is possible to provide a supply chain managing method that can evaluate a risk to a supply chain with higher accuracy by indicating the risk to the supply chain on the basis of a more appropriate scale.

Further, according to the present invention, there is provided a supply chain management system including a supply chain managing device configured to obtain a risk value with regard to a supply chain, and a visualizing device configured to visualize the risk value, the supply chain managing device including a risk data obtaining section configured to obtain risk data including a relation between a spatial position and the risk value, as data related to a risk affecting the supply chain, a risk degree calculating section configured to obtain a risk degree corresponding to a type of the risk on the basis of the risk data, a scale calculating section configured to obtain a scale as a spatial position suitable for representing the risk, on the basis of the risk degree, and a risk estimating section configured to obtain the risk value at a specified spatial position, the risk value corresponding to the scale. In this case, recognizing the risk value with regard to the supply chain is further facilitated.

Here, for example, the visualizing device visualizes the risk value corresponding to the scale. In this case, it is possible to recognize the scale serving as a reference in obtaining the risk value.

In addition, for example, for the type of the risk, the visualizing device associates the scale and the risk value corresponding to the scale with each other, and visualizes the risk value. In this case, an evaluation and a presentation can be performed with higher accuracy.

According to the present invention, it is possible to provide a supply chain managing device, a supply chain managing method, and a supply chain management system that can evaluate a risk to a supply chain with higher accuracy by indicating the risk to the supply chain on the basis of a more appropriate scale.

### BRIEF DESCRIPTION OF THE DRAWINGS

FIG. 1 is a block diagram illustrating a general configuration of a supply chain management system according to the present embodiment;

FIG. 2 is a flowchart illustrating a main flow of operation of a database (DB) server;

FIGS. 3A and 3B are diagrams illustrating examples of risk data obtained by an input-output section in S201 in FIG. 2;

FIG. 4 is a flowchart describing in detail a method by which a risk degree calculating section calculates an overall risk degree in S202 in FIG. 2;

FIG. 5A is a diagram illustrating an example of a human risk degree correspondence table, and FIG. 5B is a diagram illustrating an example of an SC risk degree correspondence table;

FIGS. 6A and 6B are flowcharts describing in detail methods by which a scale calculating section calculates a scale in S203 in FIG. 2;

FIG. 7A is a diagram illustrating a scale correspondence table, and FIG. 7B is a diagram illustrating a scale master;

FIG. 8 is a flowchart describing in detail a first example of a method by which a risk estimating section calculates a risk value in S204 in FIG. 2;

FIG. 9A is a diagram illustrating an area inclusion relation used in S803 in FIG. 8, and FIG. 9B is a diagram illustrating population statistics used in S805 in FIG. 8;

FIG. 10 is a flowchart describing in detail a second example of the method by which the risk estimating section calculates the risk value;

FIG. 11 is a diagram illustrating a user list for determining the job title level of a user; and

FIG. 12 is a diagram illustrating an example in which an application (AP) server visualizes the risk value and displays the risk value as a screen.

### DESCRIPTION OF THE PREFERRED EMBODIMENT

An embodiment of the present invention will hereinafter be described in detail with reference to the accompanying drawings.

### <General Description of Supply Chain Management System 1>

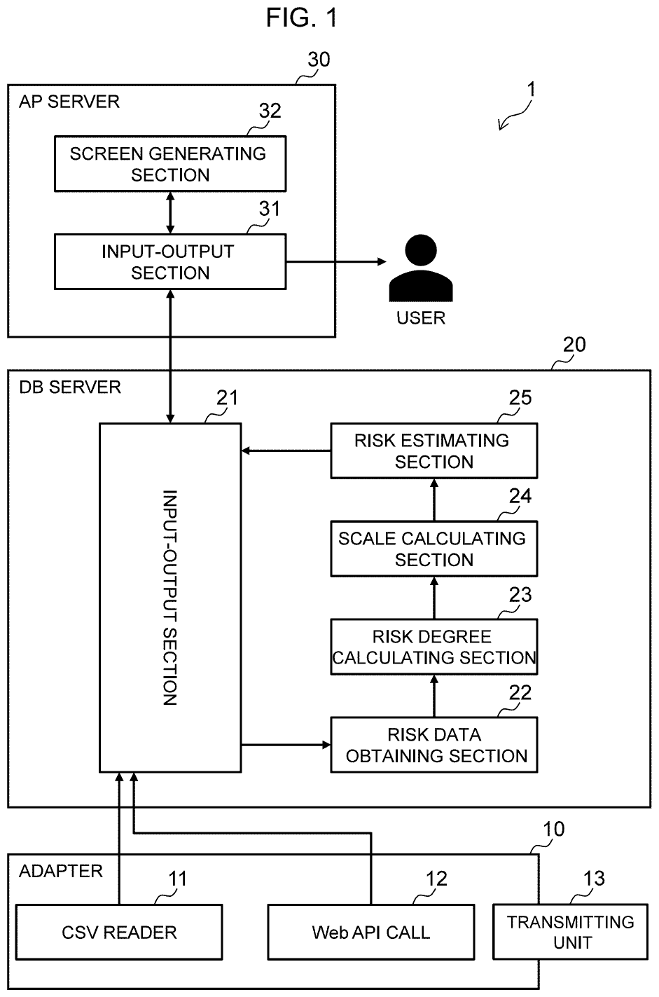

FIG. 1 is a block diagram illustrating a general configuration of a supply chain management system 1 according to the present embodiment.

The supply chain management system 1 illustrated in the figure includes an adapter 10, a DB server 20, and an AP server 30.

The adapter 10 collects data related to risks affecting a supply chain (SC). The adapter 10 illustrated in the figure includes a comma-separated values (CSV) reader 11, a Web application programming interface (API) call 12, and a transmitting unit 13.

The CSV reader 11 collects data related to risks affecting the supply chain by, for example, reading each row of a CSV file as a list. The CSV file is, for example, data related to conflicts and data related to the production of minerals, petroleum, and natural gases.

The Web API call 12 collects data related to risks affecting the supply chain by, for example, using a Web service. Here, the Web service provides, for example, such data as trade statistics, news transmitted from news media, and weather data. In addition, the Web API call 12 collects data by obtaining rich site summaries (RSS), electronic mail, and the like.

The transmitting unit 13 transmits the data related to the risks affecting the supply chain to the DB server 20.

The DB server 20 is an example of a supply chain managing device. The DB server 20 obtains an evaluation result including a risk value with regard to the supply chain. That is, the DB server 20 evaluates a risk to the supply chain and outputs an evaluation result. As will be described later in detail, the evaluation result includes a scale and a risk value for the type of risk to the supply chain.

The DB server 20 includes an input-output section 21, a risk data obtaining section 22, a risk degree calculating section 23, a scale calculating section 24, and a risk estimating section 25.

The input-output section 21 obtains the data related to risks affecting the supply chain from the adapter 10. In addition, the input-output section 21 sends the evaluation result generated in the DB server 20 to the AP server 30.

The risk data obtaining section 22 obtains risk data as data related to risks affecting the supply chain. The risk data obtaining section 22 can perform the obtainment by generating the risk data on the basis of the data related to risks which is obtained by the input-output section 21. In addition, the risk data obtaining section 22 may obtain risk data generated in advance by an administrator of the supply chain management system 1 or the like.

The “risk data” is data including a relation between a spatial position and a risk value.

The “spatial position” is a position at which a risk to the supply chain can occur. The spatial position can be represented by a location name, coordinates, and the like. More specifically, the location name can be represented by, for example, the name of a country, a region, a city, a municipality, or the like. In addition, the coordinates can be represented by a latitude and a longitude, an address, or the like.

In addition, the “risk value” is obtained by converting a risk with regard to the spatial position into a numerical value. The risk value can be represented as, for example, an integer value. In addition, the integer value may be normalized into a predetermined range such as a range of 0 to 100. Further, cases of making representations in a symbol form such as “A, B, C, D, or E” or “○, Δ, or ×” are also included.

The risk degree calculating section 23 obtains a risk degree with regard to the type of risk on the basis of the risk data.

The “risk degree” is obtained by converting a degree of risk into a numerical value with regard to the type of risk. As will be described later in detail, the risk degree calculating section 23 obtains the risk degree (overall risk degree to be described later) on the basis of a human risk degree, which is a risk degree with regard to a human, and a supply chain risk degree, which is a risk degree with regard to the supply chain. The “human risk degree” is obtained by converting a degree of risk to a human into a numerical value with regard to the type of risk. The “supply chain risk degree” is obtained by converting a degree of risk to the supply chain into a numerical value with regard to the type of risk.

The scale calculating section 24 obtains a scale as a spatial position suitable for indicating a risk, on the basis of the risk degree. That is, the scale calculating section 24 obtains a scale indicating a new spatial position as an appropriate spatial position corresponding to the type of risk.

The “scale” is obtained by converting the spatial position into a numerical value according to the extent of the area of the spatial position. This scale is determined according to the risk degree. As will be described later in detail, the higher the risk degree, the smaller the area indicated by the scale, and the lower the risk degree, the larger the area indicated by the scale.

The risk estimating section 25 obtains a risk value at a specified spatial position. The risk value corresponds to the scale. The specified spatial position can be input by a user. In addition, a spatial position affecting the supply chain may be extracted from the data collected by the adapter 10, and the spatial position may thus be determined. The specified spatial position can be represented by coordinates or the like. More specifically, the coordinates are a latitude and a longitude or the like. That is, the risk estimating section 25 obtains a risk value with respect to the scale as an appropriate spatial position corresponding to the type of risk, at a location at which the supply chain is affected. This makes it possible to obtain a risk value evaluated on the basis of a scale suitable for each type of risk. The risk value obtained by the risk estimating section 25 can be said to be a new risk value obtained by correcting the risk value included in the risk data obtained by the input-output section 21, with respect to an appropriate scale.

The AP server 30 is an example of a visualizing device. The AP server 30 operates an application for visualizing the evaluation result including the risk value output by the DB server 20, and provides the evaluation result to the user.

The AP server 30 includes an input-output section 31 and a screen generating section 32.

The input-output section 31 receives the evaluation result from the DB server 20, and transmits the evaluation result visualized by the screen generating section 32 to the user. The user can view the evaluation result of the risk to the supply chain by a browser screen that operates on a terminal device possessed by the user himself/herself, for example.

The screen generating section 32 visualizes the evaluation result by using the application, and generates an image for providing the evaluation result to the user.

The adapter 10, the DB server 20, and the AP server 30 are each a computer device, and are each, for example, a server computer. However, there is no limitation to this, and the adapter 10, the DB server 20, and the AP server 30 may each be a personal computer (PC), a mobile computer, a smart phone, a tablet, or the like. In addition, the adapter 10, the DB server 20, and the AP server 30 may each be a cloud server operating in a cloud or the like.

The adapter 10, the DB server 20, and the AP server 30 each include a processor such as a central processing unit (CPU) as arithmetic means and a main memory as storing means. Here, the processor executes various kinds of software such as an operating system (OS; basic software) and an app (application software). In addition, the main memory is a storage area for storing the various kinds of software, data used for the execution of the various kinds of software, and the like. Further, the adapter 10, the DB server 20, and the AP server 30 each include a storage such as a hard disk drive (HDD) and a solid state drive (SSD) as an auxiliary storage device and a communication interface for performing communication with the outside. In addition, the adapter 10, the DB server 20, and the AP server 30 may each include an input device such as a mouse and a keyboard and an output device such as a display.

It is to be noted that, while the adapter 10, the DB server 20, and the AP server 30 are illustrated here as separate devices, the adapter 10, the DB server 20, and the AP server 30 do not necessarily need to be separate devices. For example, processing may be performed with the adapter 10, the DB server 20, and the AP server 30 formed as one device. In addition, for example, processing may be performed with the DB server 20 and the AP server 30 formed as one device. Further, each of the adapter 10, the DB server 20, and the AP server 30 may be constituted by separate devices.

### <Detailed Description of Operation of DB Server 20>

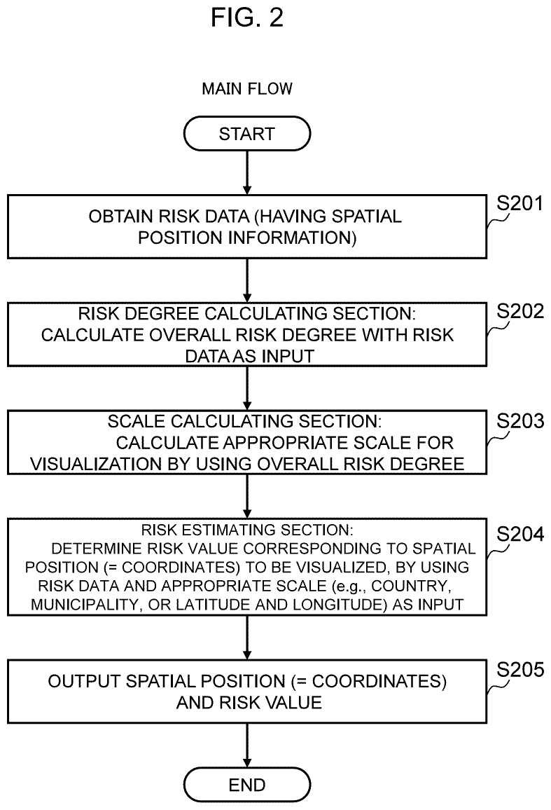

FIG. 2 is a flowchart illustrating a main flow of the operation of the DB server 20.

First, the input-output section 21 obtains risk data including the information concerning a spatial position from the adapter 10 (S201).

Next, the risk degree calculating section 23 calculates an overall risk degree by using the risk data as input (S202).

Further, the scale calculating section 24 calculates an appropriate scale for visualizing a risk value by using the overall risk degree (S203).

Further, the risk estimating section 25 determines the risk value corresponding to the spatial position (=coordinates) to be visualized by using the risk data and the appropriate scale as input (S204).

Furthermore, the input-output section 21 outputs the spatial position (=coordinates) and the risk value (S205).

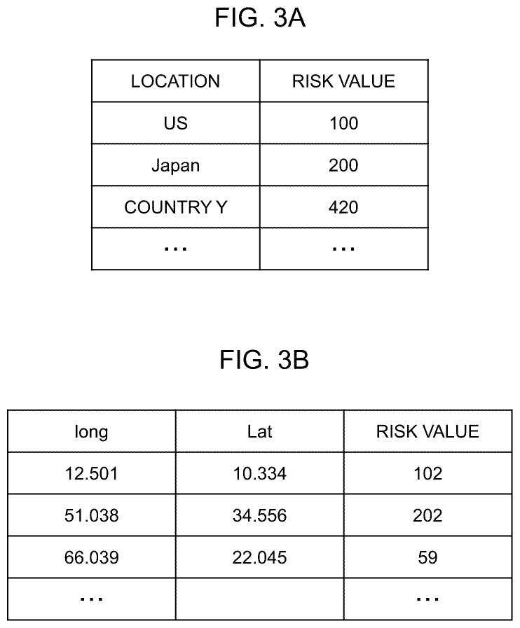

FIGS. 3A and 3B are diagrams illustrating examples of the risk data obtained by the input-output section 21 in S201 in FIG. 2.

As described above, the risk data is data including a relation between a spatial position and a risk value.

FIG. 3A represents a case where the spatial position is set to be a country. In this case, a location name is the name of the country. Further, the risk values of the United States of America (US), Japan, and a country Y are set as 100, 200, and 420, respectively.

In addition, FIG. 3B represents a case where the spatial position is set to be a latitude and a longitude. In this case, long is the longitude, and Lat is the latitude.

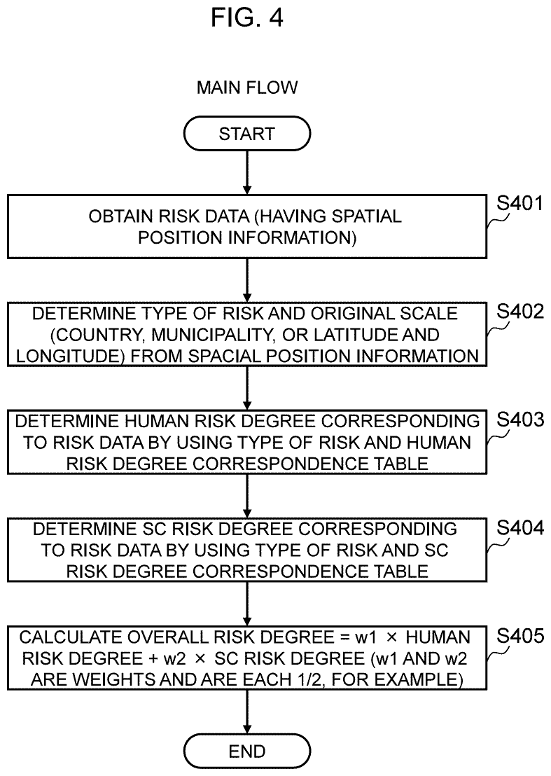

FIG. 4 is a flowchart describing in detail a method by which the risk degree calculating section 23 calculates the overall risk degree in S202 in FIG. 2.

First, the risk degree calculating section 23 obtains risk data including the information concerning a spatial position (S401).

Next, the risk degree calculating section 23 determines the type of risk and the original scale (for example, a country, a municipality, or a latitude and a longitude) from the spatial position information (S402). The original scale is the spatial position included in the risk data.

Further, the risk degree calculating section 23 determines a human risk degree corresponding to the type of risk by using the type of risk and a human risk degree correspondence table (S403).

Furthermore, the risk degree calculating section 23 determines a supply chain risk degree (SC risk degree) corresponding to the type of risk by using the type of risk and a supply chain (SC) risk degree correspondence table (S404).

The risk degree calculating section 23 calculates an overall risk degree (S405). The overall risk degree can be obtained by the following Equation.

Overall Risk Degree=w1×Human Risk Degree+w2×Supply Chain Risk Degree

(w1 and w2 are weights and are each ½, for example).

A risk degree corresponding to the supply chain can thus be obtained comprehensively including the human risk degree.

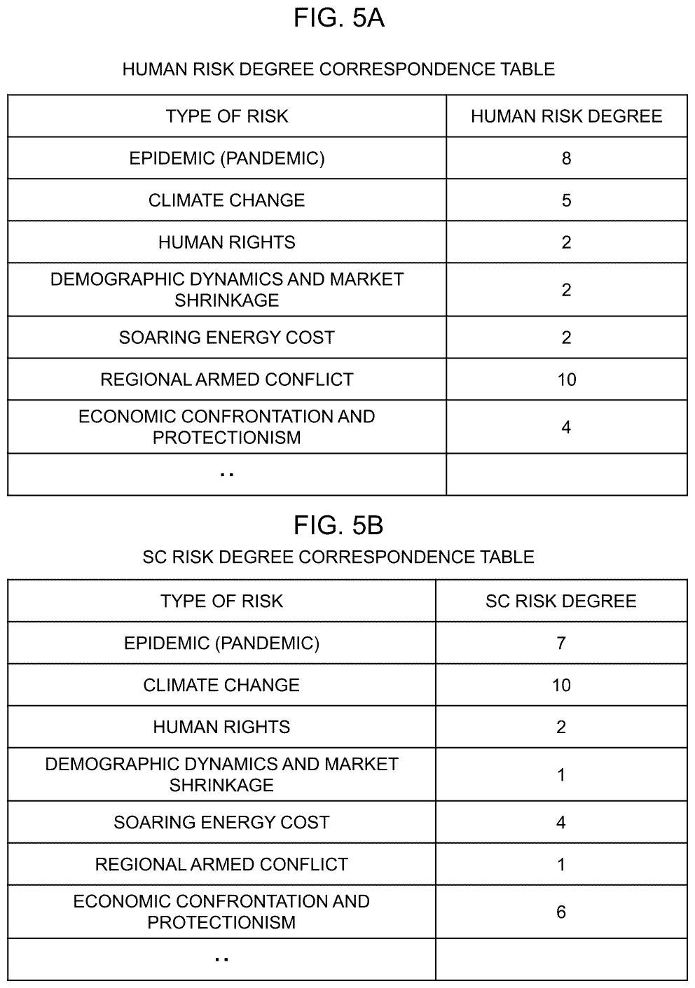

FIG. 5A is a diagram illustrating an example of the human risk degree correspondence table.

The human risk degree correspondence table is a table that associates the type of risk and the human risk degree in relation to each other. Thus, when the type of risk is known, the human risk degree is identified.

In addition, FIG. 5B is a diagram illustrating an example of the SC risk degree correspondence table.

The SC risk degree correspondence table is a table that associates the type of risk and the supply chain risk degree (SC risk degree) in relation to each other. Thus, when the type of risk is known, the supply chain risk degree (SC risk degree) is identified.

In this case, it can also be said that the risk degree calculating section 23 obtains the risk degree (overall risk degree in this case) by representing the human risk degree and the supply chain risk degree by numerical values and calculating a weighted average of the respective numerical values of the human risk degree and the supply chain risk degree. The calculation of the risk degree is facilitated by use of the numerical values.

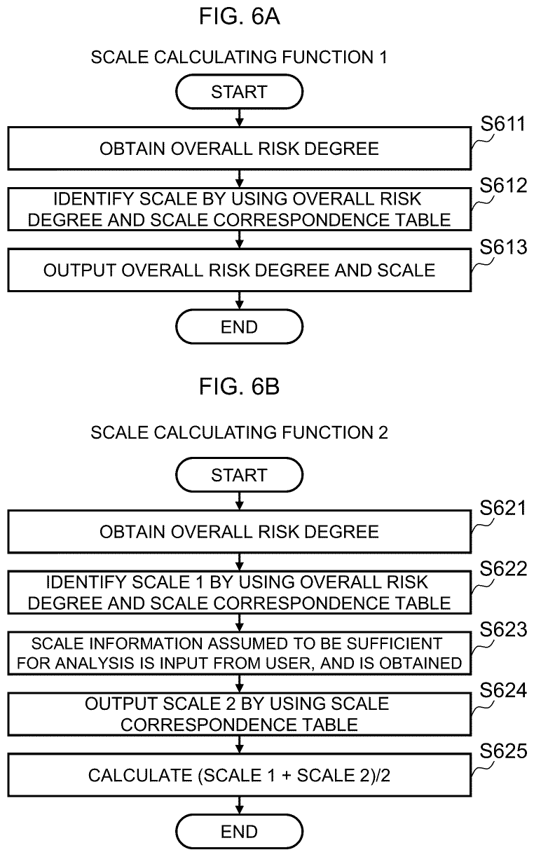

FIGS. 6A and 6B are flowcharts describing in detail methods by which the scale calculating section 24 calculates a scale in S203 in FIG. 2.

In the following, a case of calculating a scale by two different methods is illustrated.

FIG. 6A is a diagram illustrating a first example of the method for calculating a scale.

First, the scale calculating section 24 obtains the overall risk degree calculated by the risk degree calculating section 23 (S611).

Next, the scale calculating section 24 identifies a scale by using the overall risk degree and a scale correspondence table (S612). That is, the scale calculating section 24 identifies a scale corresponding to the overall risk degree by using the scale correspondence table. This scale is represented as a numerical value.

Then, the scale calculating section 24 outputs the overall risk degree and the scale (S613).

FIG. 6B is a diagram illustrating a second example of the method for calculating a scale.

First, the scale calculating section 24 obtains the overall risk degree (S621).

Next, the scale calculating section 24 identifies a scale 1 by using the overall risk degree and the scale correspondence table (S622). This scale 1 is represented as a numerical value.

Further, the information concerning a scale assumed to be sufficient for analysis is input from the user, and is obtained by the scale calculating section 24 (S623). The information concerning the scale is input as, for example, a country, a municipality, a latitude and a longitude, or the like.

Then, the scale calculating section 24 identifies a scale 2 by using the information concerning the scale obtained in S623 and the scale correspondence table (S624). This scale 2 is represented as a numerical value.

Next, the scale calculating section 24 calculates (Scale 1+Scale 2)/2 (S625). That is, the scale calculating section 24 calculates an average of the respective numerical values of the scale 1 and the scale 2. At this time, the scale calculating section 24 converts this average into an integer by rounding off the average (S625). The scale can thereby be calculated. As described above, the scale calculating section 24 determines the scale according to the magnitude of the risk degree (overall risk degree in this case). It is thus possible to set an appropriate scale for the magnitude of the risk degree. In addition, in the case of FIG. 6B, the scale calculating section 24 determines the scale on the basis of the information be a scale input from the user, in addition to the magnitude of the risk degree (overall risk degree in this case). It is thereby possible to determine the scale while incorporating a request from the user.

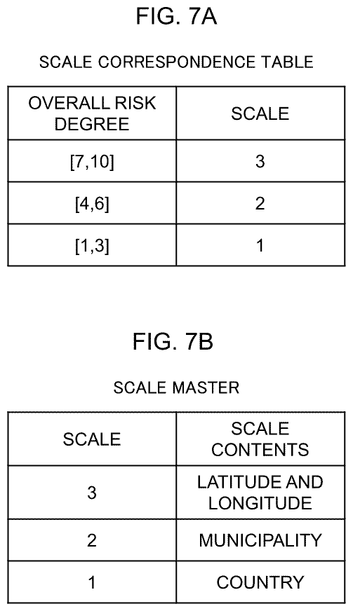

FIG. 7A is a diagram illustrating the scale correspondence table.

The scale correspondence table illustrated in the figure is a table that associates the overall risk degree and the scale in relation to each other. Thus, when an overall risk degree is known, a scale is identified. In this case, when the overall risk degree is 7 to 10, the scale is set to 3. In addition, similarly, when the overall risk degree is 4 to 6, the scale is set to 2, and when the overall risk degree is 1 to 3, the scale is set to 1. The scale is thus expressed by a numerical value. The meaning of this numerical value is managed by a scale master.

FIG. 7B is a diagram illustrating the scale master.

The scale master illustrated in the figure is a table that associates the scale and the contents of the scale in relation to each other. In this case, the scales are set as numerical values in three levels of 3, 2, and 1, which respectively mean a latitude and a longitude, a municipality, and a country. In this case, the larger the numerical value of a scale, the smaller the area, and the smaller the numerical value of the scale, the larger the area.

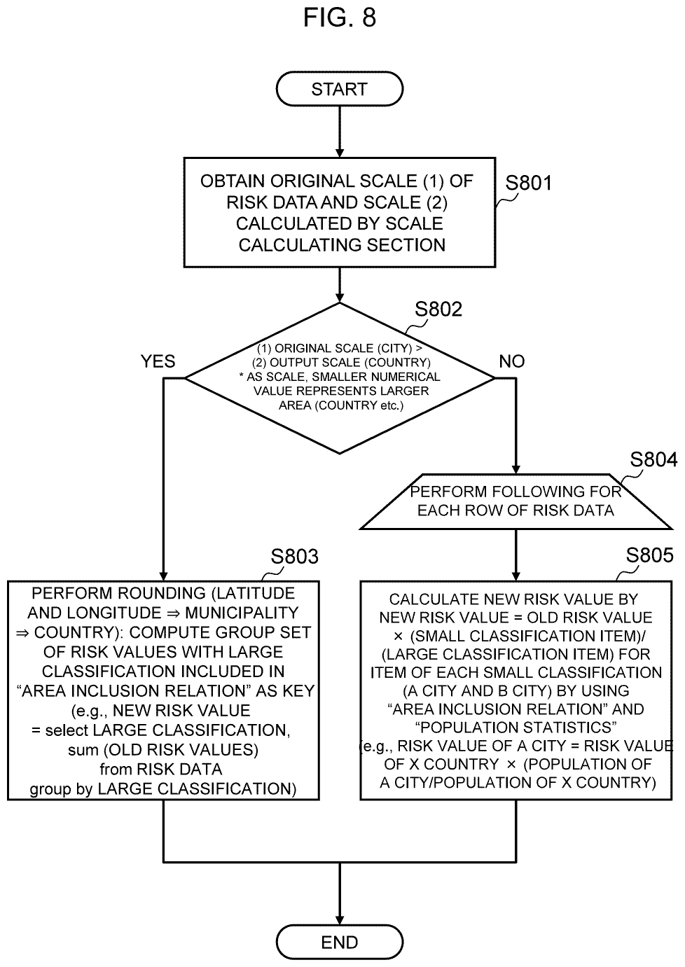

FIG. 8 is a flowchart describing in detail a first example of a method by which the risk estimating section 25 calculates the risk value in S204 in FIG. 2.

In the following, there is illustrated a method in which the risk estimating section 25 calculates a risk value corresponding to a spatial position (=coordinates) to be visualized.

First, the risk estimating section 25 obtains the original scale (1) included in the risk data and the scale (2) calculated by the scale calculating section 24 (S801).

Next, the risk estimating section 25 determines whether Original Scale (1)>Scale (2) holds (S802). That is, the risk estimating section 25 compares the numerical values of the original scale (1) and the scale (2) with each other, and determines the magnitude relation therebetween.

As a result, when Original Scale (1)>Scale (2) holds (Yes in S802), the area of the original scale (1) is smaller than the area of the scale (2). In this case, the scale (2) suitable for expressing the risk value represents a larger area than the original scale (1). For example, this applies to a case in which the original scale (1) is a municipality and the scale (2) is a country. In addition, for example, this also applies to a case in which the original scale (1) is a latitude and a longitude and the scale (2) is a municipality.

In this case, the risk estimating section 25 rounds the numerical value by using an area inclusion relation between the original scale (1) and the scale (2). Specifically, the risk estimating section 25 sums risk values within areas included in the scale (2) by using the area inclusion relation between the original scale (1) and the scale (2) (S803). For example, in a case where the scale (2) is a country X and the country X includes a city A and a city B as the area inclusion relation, the risk estimating section 25 sums the risk values of the city A and the city B.

When Original Scale (1)>Scale (2) does not hold (No in S802), on the other hand, Original Scale (1)≤Scale (2) holds. This is a case where the scale (2) suitable for expressing the risk value represents a smaller area than the original scale (1). For example, this applies to a case in which the original scale (1) is a country and the scale (2) is a municipality. In addition, for example, this also applies to a case in which the original scale (1) is a municipality and the scale (2) is a latitude and a longitude.

In this case, the risk estimating section 25 performs the following processing for each row of the risk data (S804).

The risk estimating section 25, for example, decreases the risk value included in the risk data, according to a ratio between the population included in the original scale (1) and the population included in the scale (2), by using population statistics (S805). For example, the risk estimating section 25 obtains the risk value by the following equation.

Risk Value=Risk Value Included in Risk Data×(Population Included in Scale (2)/Population Included in Original Scale (1))

More specifically, in a case where the country X includes the city A and the city B, the original scale (1) is the country X, and the scale (2) is the city A, the risk estimating section 25 obtains the risk value of the city A by the following equation.

Risk Value of City A=Risk Value of Country X×(Population of City A/Population of Country X)

The risk estimating section 25 performs the following processing for each row of the risk data, and thus similarly obtains the risk value of the city B.

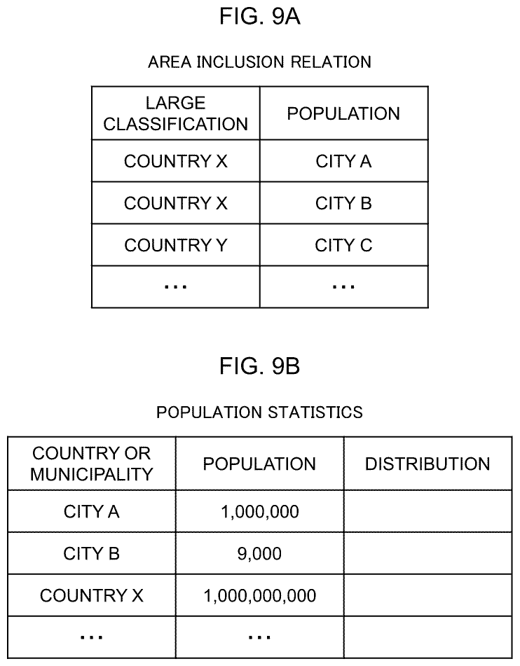

FIG. 9A is a diagram illustrating the area inclusion relation used in S803 in FIG. 8.

Here, it is indicated that the country X includes the city A and the city B. In addition, it is indicated that the country Y includes a city C.

FIG. 9B is a diagram illustrating the population statistics used in S805 in FIG. 8.

Here, it is indicated that the populations of the city A, the city B, and the country X are 1,000,000, 9,000, and 1,000,000,000, respectively.

It can also be said that, in a mode illustrated in FIGS. 8 to 9B, the risk estimating section 25 calculates a risk value corresponding to a scale on the basis of the magnitude relation between the spatial position included in the risk data (original scale (1) in this case) and the scale calculated by the scale calculating section 24 (scale (2) in this case). The risk value included in the risk data can thus be corrected to be a more appropriate risk value.

More specifically, it can also be said that, in a case where the scale calculated by the scale calculating section 24 (scale (2) in this case) represents a smaller area than the spatial position included in the risk data (original scale (1) in this case), the risk estimating section 25 calculates the risk value corresponding to the scale by decreasing, according to the scale, the risk value included in the risk data, and in a case where the scale represents a larger area than the spatial position included in the risk data, the risk estimating section 25 calculates the risk value corresponding to the scale by increasing, according to the scale, the risk value included in the risk data. Thus, increasing or decreasing the risk value according to the size of the spatial position makes it possible to calculate a more appropriate risk value.

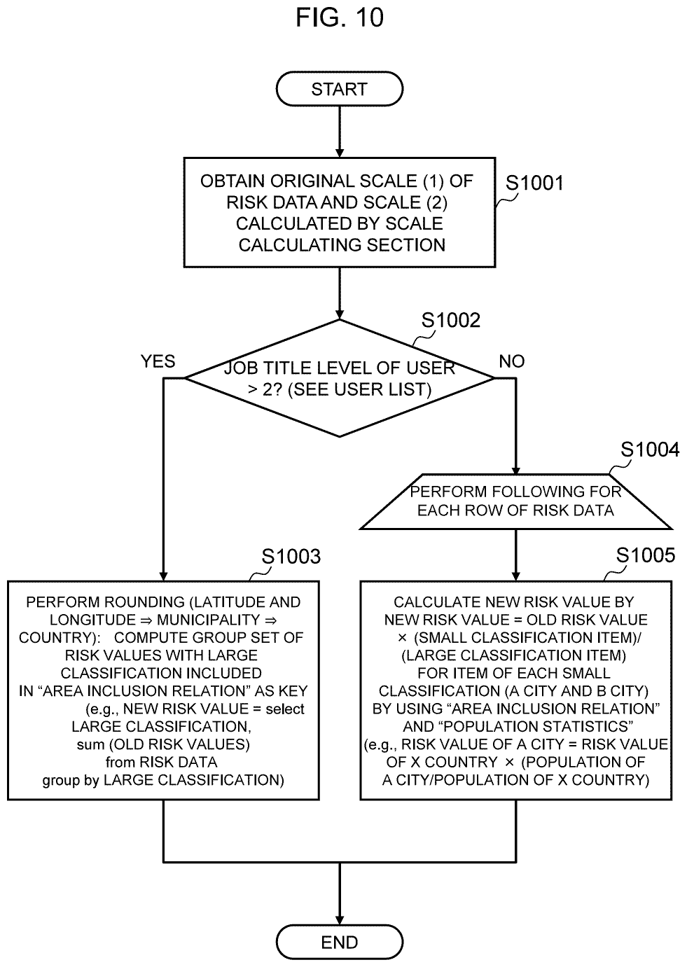

FIG. 10 is a flowchart describing in detail a second example of the method by which the risk estimating section 25 calculates the risk value.

A comparison between FIG. 10 and FIG. 8 indicates that S1001 and S1003 through S1005 in FIG. 10 are similar to S801 and S803 through S805 in FIG. 8 but S1002 differs from S802. Hence, S1002 will mainly be described in the following.

The risk estimating section 25 determines whether the job title level of the user exceeds two (job title level of user>2) (S1002). That is, the risk estimating section 25 compares the job title level of the user represented by a numerical value with two as a threshold value, and determines the magnitude relation therebetween.

When the job title level of the user exceeds two (job title level of user>2) as a result (Yes in S1002), a transition is made to S1003.

When the job title level of the user does not exceed two (job title level of user≤2) (No in S1002), on the other hand, a transition is made to S1004.

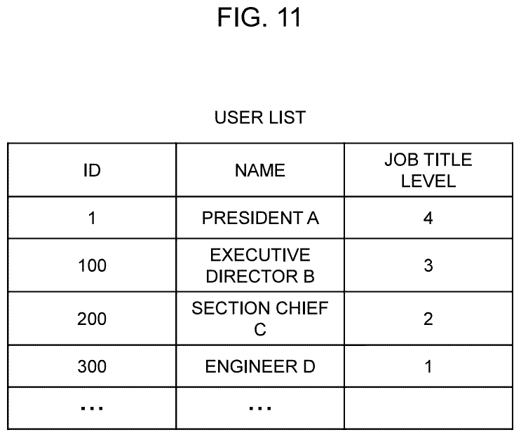

FIG. 11 is a diagram illustrating a user list for determining the job title level of the user.

The user list illustrated in the figure includes information concerning an identification (ID), a name, and a job title level of each user. Here, job title levels are set by numerical values in four levels of 4, 3, 2, and 1, which respectively mean a president, a senior executive, an ordinary executive, and an ordinary employee.

Here, the risk estimating section 25 calculates a risk value corresponding to a scale on the basis of a rank set for the user. The rank set for the user is, for example, the job title level of the user. The risk value included in the risk data can thus be corrected to be a more appropriate risk value according to the rank set for the user. That is, demanded duties, responsibilities, and the like differ according to the job title level of the user and the like, and thus, the risk value changes according to the user. Hence, here, the risk value is obtained with this content also taken into consideration.

In addition, in this case, it can also be said that, according to the magnitude relation between the numerical value indicating the rank and the predetermined threshold value (two in this case), the risk estimating section 25 determines whether to calculate the risk value corresponding to the scale by decreasing, according to the scale, the risk value included in the risk data, or calculate the risk value corresponding to the scale by increasing, according to the scale, the risk value included in the risk data. Thus, increasing or decreasing the risk value according to the rank set for the user makes it possible to calculate a more appropriate risk value.

### <Detailed Description of Operation of AP Server 30>

As described above, the AP server 30 visualizes the evaluation result including the risk value output by the DB server 20. At this time, the AP server 30 visualizes the risk value corresponding to the scale calculated by the scale calculating section 24. It is thus possible to recognize the scale serving as a reference in obtaining the risk value. More specifically, for the type of risk, the AP server 30 associates the scale calculated by the scale calculating section 24 and the risk value corresponding to the scale with each other, and visualizes the risk value. Recognizing the risk value with regard to the supply chain is thus further facilitated.

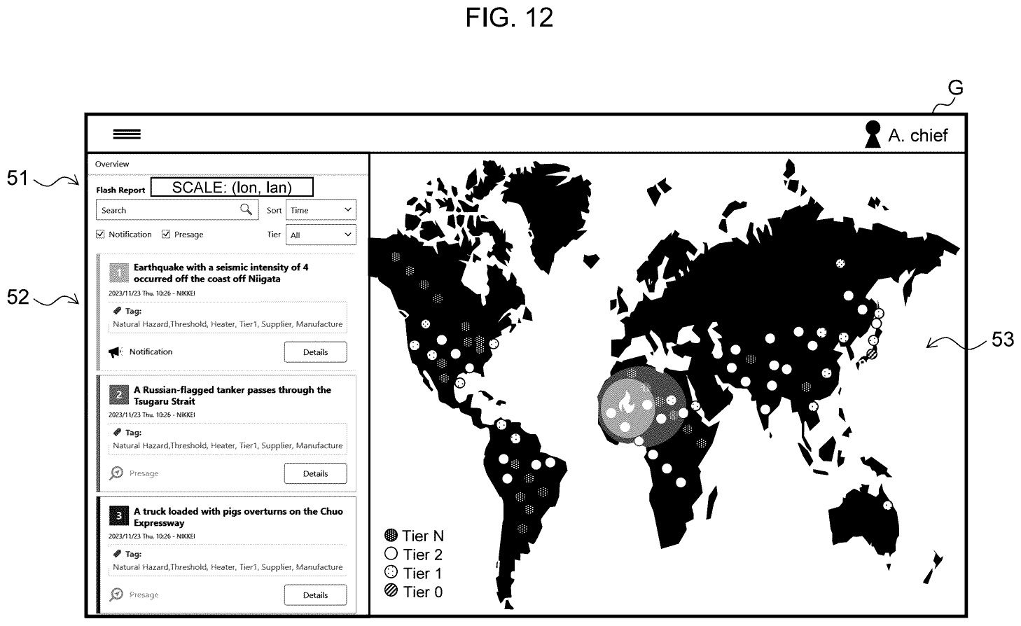

FIG. 12 is a diagram illustrating an example in which the AP server 30 visualizes the risk value and displays the risk value as a screen.

On a screen G illustrated in the figure, a scale 51 is displayed on a left upper side of the screen G. Here, it is indicated that the scale 51 is a longitude (long) and a latitude (Lat). In addition, types of risks 52 are displayed on a left lower side of the screen G. Here, the types of risks are represented by 1 to 3.

Further, a map is displayed on the right side of the screen G, and risk values 53 are displayed in such a manner as to be superimposed on corresponding locations on the map. Here, the risk values 53 corresponding to the types of risks 1 to 3 are displayed by a map graph.

According to a mode described above in detail, it is possible to provide the supply chain managing device as the DB server 20 that can evaluate a risk to the supply chain with higher accuracy by indicating the risk to the supply chain on the basis of a more appropriate scale.

### <Description of Supply Chain Managing Method>

The processing performed by the DB server 20 is implemented by cooperation between software and hardware resources. That is, the processor such as a CPU provided to the DB server 20 loads a program for implementing the functions of the DB server 20 into the main memory, and executes the program. The processor thereby implements the functions.

Hence, the processing performed by the DB server 20 described above can be regarded as a supply chain managing method performed by a processor executing a program recorded in a memory, the supply chain managing method including obtaining risk data including a relation between a spatial position and a risk value as data related to a risk affecting a supply chain, obtaining a risk degree corresponding to the type of the risk on the basis of the risk data, obtaining a scale as a spatial position suitable for representing the risk, on the basis of the risk degree, and obtaining the risk value at a specified spatial position, the risk value corresponding to the scale. It is thus possible to provide a supply chain managing method that can evaluate a risk to a supply chain with higher accuracy by indicating the risk to the supply chain on the basis of a more appropriate scale.

In addition, a program that operates on the DB server 20 can be regarded as a program for making a computer implement a function of obtaining risk data including a relation between a spatial position and a risk value as data related to a risk affecting a supply chain, a function of obtaining a risk degree corresponding to the type of the risk on the basis of the risk data, a function of obtaining a scale as a spatial position suitable for representing the risk, on the basis of the risk degree, and a function of obtaining the risk value at a specified spatial position, the risk value corresponding to the scale. It is thus possible to implement, by a computer, the functions that can evaluate a risk to a supply chain with higher accuracy by indicating the risk to the supply chain on the basis of a more appropriate scale.

Incidentally, the program for implementing the present embodiment can be provided not only by communicating means, but also in a state of being stored on a recording medium such as a compact disc read only memory (CD-ROM).

The present embodiment has been described above. However, the technical scope of the present invention is not limited to the scope described in the foregoing embodiment. It is obvious from the description of claims that embodiments obtained by making various changes or improvements to the foregoing embodiment are also included in the technical scope of the present invention.

What is claimed is:

1. A supply chain managing device comprising:
a risk data obtaining section configured to obtain risk data including a relation between a spatial position and a risk value, as data related to a risk affecting a supply chain;
a risk degree calculating section configured to obtain a risk degree corresponding to a type of the risk on a basis of the risk data;
a scale calculating section configured to obtain a scale as a spatial position suitable for representing the risk, on a basis of the risk degree; and
a risk estimating section configured to obtain the risk value at a specified spatial position, the risk value corresponding to the scale.

2. The supply chain managing device according to claim 1, wherein
the risk degree calculating section obtains the risk degree on a basis of a human risk degree as a risk degree with regard to a human and a supply chain risk degree as a risk degree with regard to the supply chain.

3. The supply chain managing device according to claim 2, wherein
the risk degree calculating section obtains the risk degree by representing the human risk degree and the supply chain risk degree by numerical values and calculating a weighted average of the respective numerical values of the human risk degree and the supply chain risk degree.

4. The supply chain managing device according to claim 1, wherein
the scale calculating section obtains the scale according to magnitude of the risk degree.

5. The supply chain managing device according to claim 4, wherein
the scale calculating section obtains the scale on a basis of information concerning a scale input from a user, in addition to the magnitude of the risk degree.

6. The supply chain managing device according to claim 1, wherein
the risk estimating section calculates the risk value corresponding to the scale on a basis of a magnitude relation between the spatial position included in the risk data and the scale calculated by the scale calculating section.

7. The supply chain managing device according to claim 6, wherein
the risk estimating section calculates the risk value corresponding to the scale by decreasing, according to the scale, the risk value included in the risk data, when the scale represents a smaller area than the spatial position included in the risk data, and calculates the risk value corresponding to the scale by increasing, according to the scale, the risk value included in the risk data, when the scale represents a larger area than the spatial position included in the risk data.

8. The supply chain managing device according to claim 1, wherein
the risk estimating section calculates the risk value corresponding to the scale on a basis of a rank set for a user.

9. The supply chain managing device according to claim 8, wherein,
according to a magnitude relation between a numerical value indicating the rank and a predetermined threshold value, the risk estimating section determines whether to calculate the risk value corresponding to the scale by decreasing, according to the scale, the risk value included in the risk data, or calculate the risk value corresponding to the scale by increasing, according to the scale, the risk value included in the risk data.

10. A supply chain managing method performed by a processor executing a program recorded in a memory, the supply chain managing method comprising:
obtaining risk data including a relation between a spatial position and a risk value as data related to a risk affecting a supply chain;
obtaining a risk degree corresponding to a type of the risk on a basis of the risk data;
obtaining a scale as a spatial position suitable for representing the risk, on a basis of the risk degree; and
obtaining the risk value at a specified spatial position, the risk value corresponding to the scale.

11. A supply chain management system comprising:
a supply chain managing device configured to obtain a risk value with regard to a supply chain; and
a visualizing device configured to visualize the risk value,
the supply chain managing device including
a risk data obtaining section configured to obtain risk data including a relation between a spatial position and the risk value as data related to a risk affecting the supply chain,
a risk degree calculating section configured to obtain a risk degree corresponding to a type of the risk on a basis of the risk data,
a scale calculating section configured to obtain a scale as a spatial position suitable for representing the risk, on a basis of the risk degree, and
a risk estimating section configured to obtain the risk value at a specified spatial position, the risk value corresponding to the scale.

12. The supply chain management system according to claim 11, wherein
the visualizing device visualizes the risk value corresponding to the scale.

13. The supply chain management system according to claim 12, wherein,
for the type of the risk, the visualizing device associates the scale and the risk value corresponding to the scale with each other, and visualizes the risk value.
